(19) United States
(12) Patent Application Publication
(10) Pub. No.: US 2011/0084793 A1
(43) Pub. Date: Apr. 14, 2011

(54) Tri-Mode Over-Voltage Protection and Disconnect Circuit Apparatus and Method

(75) Inventor: Demian Martin, San Leandro, CA (US)

(73) Assignee: Monster Cable Products, Inc., Brisbane, CA (US)

(21) Appl. No.: 12/900,416

(22) Filed: Oct. 7, 2010

Related U.S. Application Data
(60) Provisional application No. 61/250,312, filed on Oct. 9, 2009.

(51) Int. Cl. H01H 85/00

(52) U.S. Cl. 337/142

(57) ABSTRACT

A single-phase apparatus and method for protecting for all AC power wires/lines and combinations thereof. The present invention prevents (1) the hazardous condition occurring at the wall receptacle, arising from accidental reversal of the line wire with the neutral wire, from adversely affecting at least one peripheral device in the line, and (2) the overheating and destruction of components in an over-voltage protection circuit by providing an efficient circuit configuration which assures a rapid simultaneous disconnect of both the hot line and neutral power lines.

### PRIORITY CLAIM

This application claims priority to Provisional Patent Application No. 61/250,312, Improved Tri-Mode Over-Voltage Protection and Disconnect Circuit Apparatus and Method, filed on Oct. 9, 2009.

### TECHNICAL FIELD

The present invention relates to over-voltage protection circuits. More particularly, the present invention relates to over-voltage protection circuits having metal oxide varistor (MOV) devices as the over-voltage sensing component. Even more particularly, the present invention relates to over-voltage protection circuits having metal oxide varistor (MOV) devices as the over-voltage sensing component for utilization in AC electric power distribution.

### BACKGROUND OF THE INVENTION

The current state of the art electronic components (e.g., both commercial and residential computers and related equipment) accommodate transient voltage surge suppression features for protecting their highly sensitive circuits from over-voltage damage. Most transient voltage surge suppression systems today address only minor fault conditions associated with normal use and cannot handle a major over-voltage condition as would occur during loss of neutral, loss of ground, or repetitive current pulses (e.g., from a lightning strike). However, the hot line, neutral, and ground wires are all paths vulnerable to destructive high voltages. Typical voltage surge protection devices comprise a plurality of fault fuses where the input is disconnected from the output as a result of an over-current condition resulting from the over-voltage. The related art surge suppression systems may also involve various metal oxide varistor (MOV) and fuse combinations. MOVs are typically non-linear devices formed from composite ceramic materials (e.g., ZnO grains in combination with an amorphous material). MOVs maintain the voltage within a narrow band (i.e., varistor voltage) over a wide current range. During major over-voltage conditions, the MOVs may absorb heat so excessive that they will rupture or explode, thereby causing destruction of the related electronic equipment.

Some related art surge suppression apparatus patents include:
(1) U.S. Pat. No. 6,683,770 to Marsh, which teaches a plurality of MOVs in series with a plurality of thermal fuses;
(2) U.S. Pat. No. 6,055,147 to Jeffries et al. which teaches a plurality of MOVs being in series with a plurality of thermal fuses;
(3) U.S. Pat. No. 5,412,526 to Kapp et al. which teaches a plurality of MOVs being in series with a plurality of thermal fuses, and the plurality of MOVs being in parallel with a plurality of resistors;
(4) U.S. Pat. No. 6,040,971 to Martenson et al. which teaches a plurality of MOVs being in parallel with one another, an MOV being in parallel with a thermal fuse, and the thermal fuse being in series with a circuit protection device having an over-voltage trip device;
(5) U.S. Pat. No. 5,388,021 to Stahl which teaches a plurality of MOVs being in parallel with a plurality of resistors and a plurality of inductors, and a plurality of MOVs being in parallel with another;
(6) U.S. Pat. No. 5,675,468 to Chang which teaches two input terminals, two fuses in series respectively, a triac, an MOV in series between one fuse and an output terminal, a static potential limiter between the triac and ground;
(7) U.S. Pat. No. 4,901,183 to Lee which teaches two MOVs being in parallel with one another, two thermal fuses being in parallel with one another, a capacitor being in parallel with an MOV, two capacitors being in parallel with one another, and two inductors being in parallel with one another;
(8) U.S. Pat. No. 6,038,117 to Dullni et al. which teaches pairs of MOVs being in parallel, a plurality of such pairs being in series with one another and in series with a relay;
(9) U.S. Pat. No. 5,534,769 to Ishii which teaches resistor-capacitor combinations; and
(10) U.S. Pat. No. 5,808,850 to Carpenter, Jr. which teaches a three-phase device having quadruplets of parallel MOVs, each quadruplet being in series with a thermal fuse and an inductor, and bulbs for an indicator light for line to ground only.

A typical problem not always addressed by related prior art devices arises if an electrician accidentally reverses the line wire and the neutral wire, creating an extremely hazardous situation at the wall receptacle. In that event, the device may not adequately succeed in disconnecting the circuit to a peripheral device. In addition, the related art patents maintain an inordinately high component count to achieve their purpose of surge suppression. Therefore, a need exists for a circuit apparatus and a method which prevents (1) the hazardous condition arising from accidental reversal of the line wire with the neutral wire, from adversely affecting at least one peripheral device connected thereto, and (2) the overheating and destruction of MOVs in an over-voltage protection circuit by providing an efficient circuit configuration (i.e., the minimum number of components for device size reduction) which assures a rapid simultaneous disconnect of both the hot line and the neutral line.

### BRIEF SUMMARY OF THE INVENTION

An object of the present invention is to provide an apparatus and a method which prevents (1) the hazardous condition occurring at the wall receptacle arising from accidental reversal of the line wire with the neutral wire, from adversely affecting at least one peripheral device in the line, and (2) the overheating and destruction of MOVs in an over-voltage protection circuit by providing an efficient circuit configuration (i.e., the minimum number of components for device size reduction) which assures a rapid simultaneous disconnect of both the hot line and neutral power lines.

The present invention achieves this by opening the circuit to simultaneously disconnect both line and neutral power lines feeding a load when the over-voltage event occurs in any of three wire pairings: line-to-neutral, line-to-ground, or neutral-to-ground. The present invention protects these paths by first providing protection devices in the form of metal oxide varistors (MOVs) for each pair of wires (i.e., hot or line to neutral, hot or line to ground, and neutral to ground). In addition, the devices (MOVs) absorb all the extra and potentially damaging power surges and over-voltages. In the event of a sufficiently high voltage from hot line to neutral, causing excessive heating of the protection devices, the hot line and neutral wires will be disconnected from the users connected equipment through the use of thermal fuses placed beside each MOV. This non-resettable disconnect is the final protection to the connected equipment which prevents excessive heating otherwise leading to smoke and/or fire.

Another object of the present invention is to provide an apparatus and a method which prevent (1) the hazardous condition occurring at the wall receptacle which arises from accidental reversal of the line wire with the neutral wire, from adversely affecting at least one peripheral device in the line, and (2) the overheating and destruction of MOVs in an over-voltage protection circuit by opening the circuit to simultaneously disconnect both the hot line and the neutral line feeding a load when the over-voltage event occurs in any of three wire pairings: line-to-neutral (L-N), line-to-ground (L-G), or neutral-to-ground (N-G).

Accordingly, the present invention provides a single-phase over-voltage protection circuit apparatus for all AC power lines and combinations thereof. In particular, the present invention provides an apparatus and a method which prevent (1) the hazardous condition occurring at the wall receptacle arising from accidental reversal of the line wire with the neutral wire from adversely affecting at least one peripheral device in the line, and (2) the overheating and destruction of MOVs in an over-voltage protection circuit by providing an efficient circuit configuration which assures a rapid simultaneous disconnect of both the hot line and neutral line. The present invention achieves this by opening the circuit to disconnect either or both of the hot line and neutral line feeding a load when the over-voltage event occurs in any of the three following wire pairings: hot line to neutral line (L-N), hot line to ground line (L-G), or neutral line to-ground line (N-G).

By example, in a single phase AC power system, the hot line (L), the neutral line (N), and ground line (G) are all paths vulnerable to destructive high voltages. The present invention protects these paths by providing protection devices in the form of metal oxide varistors (MOVs) in parallel for each pair of wires (i.e., hot line to neutral, hot line to ground, and neutral to ground). The apparatus additionally comprises in-line fuses that disconnect both the hot line as well as the neutral line from the load. The MOV devices are activated by an over-voltage condition and absorb the extra and potentially damaging power surges and over-voltages; when the capacity of a MOV is exceeded, the MOV will generate excessive surface heat to transfer and current to flow to a thermal fuse, which then open the fuse to protect the load.

More specifically, the thermal fuses responsible for disconnecting either the hot line and neutral line are thermally linked to an intermediate resistor, which in turn is electrically linked to the surge protection circuit. One means of linking the resistor to the surge protection circuit is by way of another thermal fuse (proximally located to the MOV) and switch, as illustrated in the attached figures.

Accordingly, in the event of a sufficiently high voltage (i.e., V_{L-N}>120V to 130V), from hot line-to-neutral or hot line-to-ground, causing excessive heating of the MOV protection devices, the hot line and neutral line will be disconnected from the users connected equipment. This disconnect is facilitated by the use of an open circuit condition of the in-line special thermal fuses, a non-resettable disconnect condition. The blown thermal fuses must be replaced to restore the circuit.

The current through the line may be denoted by I_{L}. The current through an MOV, I_{MOV}, must remain less than the rated current for the MOV, I_{MOV-rated}, in normal operation. During an over-voltage event where the current through the MOV exceeds its current rating (i.e., I_{MOV}>I_{MOV-rated}), thereby emitting high surface temperature and effecting a current through the thermal fuse which exceeds its current rating (I_{L}=I_{TF}, I_{TF}>I_{TF-rated}), such thermal fuse will open, thereby preventing voltage application to the load (See FIG. 1).

In all the foregoing protection modes (i.e., L-N, L-G, N-G), a warning feature may be provided which indicates that a protection device (e.g., an MOV) has absorbed an excessive energy, thereby opening a thermal fuse which effectively opens the path to any protection device and to the load. The warning feature may continue to alert the user even if power is no longer applied to the equipment. This warning feature alerts the user of the otherwise potentially destructive event. Upon so alerting the user, the apparatus should be unplugged from the wall outlet and the thermal fuse replaced. This warning feature may be audio and/or visual in nature.

Other features of the present invention are disclosed, or are apparent in the section entitled “DETAILED DESCRIPTION OF THE INVENTION.”

### BRIEF DESCRIPTION OF DRAWING

For a fuller understanding of the present invention, the accompanying drawing is below-referenced.

FIG. 1 is a schematic view of a tri-mode over-voltage protection and disconnect circuit apparatus, according to the prior art.

FIG. 2 is a schematic view of a tri-mode over-voltage protection and disconnect circuit apparatus, in accordance with the present invention.

### DETAILED DESCRIPTION OF THE INVENTION

### Preferred Embodiment of the Apparatus

The figures schematically illustrate the preferred embodiment of a single-phase tri-mode over-voltage circuit protection apparatus, in accordance with the present invention. By example, the apparatus comprises: an electronic circuit comprising a power input portion, having three power input connectors that electrically couple to a hot line, a neutral line, and aground line disposed internal to the over-voltage protection apparatus. By example, power input portion receives AC power from a single phase power source comprising a 120V AC line voltage measured from line-to-neutral and includes a safety ground line (not shown). Under normal operations during use of the present invention, the circuit lines electrically couple the AC power source to at least one peripheral device (not shown) via power output portion. The power output portion, by example, may comprise three or more power output connectors (not shown) that distribute AC power via continuation of hot line, neutral line, and ground line to a peripheral device (not shown). The power output connectors being electrically coupled with at least one peripheral device.

In the preferred embodiment, four protection devices, such as metal oxide varistors (MOVs) absorb any power surges and over-voltages. Each of the four MOVs are disposed between three line pairings, namely two MOVs between hot line to neutral line (L-N), one MOV between hot line to ground line (L-G), and one MOV between neutral line to ground line (N-G). The apparatus further comprises thermal fuses in series with said MOVs.

Under normal operating condition, MOV devices are high impedance components which facilitate distribution of the line voltage to any connected peripheral equipment. MOVs are capable of absorbing some transient over-voltages without failure, thereby protecting the connected peripheral devices.

During an excessive over-voltage event, the particular affected MOV is responsive by a lowering of its impedance such that the current through the device is greater than its current rating. This effectively results in a current demand through a thermal fuse greater than its current rating. Such over-voltage condition causes an affected thermal fuse to open (blow). The opening of the fuse prevents excessive heating of the affected respective MOVs. For safety reasons, the ground line is not disconnected from the ground output G at the output connector.

The apparatus may further comprise a warning feature (i.e., an over-voltage indicator) for indicating that at least one of the MOVs has responded to an over-voltage condition which has effected opening of at least one respective thermal fuse. The warning feature comprises at least one warning feature selected from a group of warning features consisting essentially of an indicator light and an LED indicator, warning that AC power has been disconnected to the peripheral equipment due to an over-voltage (O-V) condition. As depicted and by example only, the warning feature is energized from the input AC power source. The indicator devices will be normally on to indicate that the device is operating normally. When an overvoltage causes disconnection of either hot line or neutral line, the indicator lights will be extinguished, indicating that the device has disconnected power to the load. The apparatus may be disengaged from the power source after alerting by the warning feature, and may then be replaced. Apparatus may optionally include ON/OFF switches (not shown), for power distribution, and/or for safety considerations, Further, apparatus may include electronic filters at either the input or output sides to remove interference such as static or noise, as is known in the art.

A tri-mode over-voltage protection and disconnect circuit apparatus may comprise a first over-voltage protection circuit disposed between a hot line and a ground line; second and third over-voltage protection circuits disposed between the hot line and a neutral line; and a fourth over-voltage protection circuit disposed between the neutral line and the ground line.

### PREFERRED EMBODIMENT OF THE METHOD

The preferred method of the present invention comprises protecting a plurality of peripheral devices by providing a tri-mode over-voltage circuit protection apparatus, in accordance with the present invention. By example, the method comprises the steps of providing an electronic circuit, distributing power under normal operating conditions, disconnecting power distribution to peripheral equipment in response to an over-voltage condition occurring on any of the three electrical lines in a single phase electrical power system, namely line-to-neutral, line-to-ground and neutral-to-ground, indicating loss of power due to an over-voltage condition, and restoring power to the peripheral equipment by replacing/resetting the fuses of apparatus as required. Apparatus may include providing ON/OFF switches for power distribution, and/or for safety considerations and may further include providing an electronic interference filter at either the input or output of the device.

An example of the present invention method of protecting at least one peripheral device from an over-voltage condition comprises: providing a tri-mode over-voltage protection and disconnect circuit apparatus, the apparatus comprising a first and second over-voltage protection circuit disposed between a hot line and a neutral line, a third over-voltage protection circuit disposed between the hot line and aground line, and a fourth over-voltage protection circuit disposed between the neutral line and the ground line, the apparatus providing AC power to the at least one peripheral device, whereby the hot line and the neutral line are not distributed as an output voltage in the event of an over-voltage condition wherein at least one of the first, second, third and fourth over-voltage protection circuits respond by allowing sufficient current to pass to open a thermal fuse, thereby causing an open state for preventing a hazardous condition at the power source, the hazardous condition arising from an accidental reversal of the hot line wire with the neutral line, and for preventing overheating and destruction of the protection circuits by providing the disconnect of both the hot line and the neutral line; responding to an over-voltage condition, the responding step being activated by at least one of the provided over-voltage protection circuits.

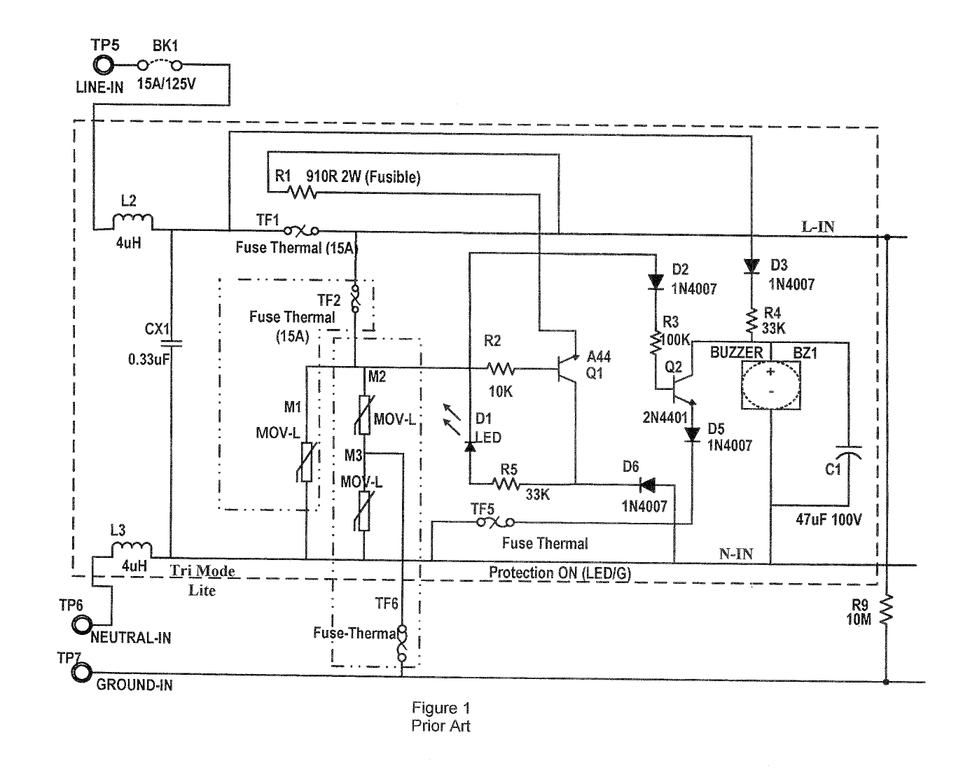

In FIG. 1, there is shown the prior art related to the present invention. In the event of over-voltage, thermal fuse TF1 disconnects power applied to TP1. Resistor R1 overheats to open the circuit and activate switching circuit transistor Q1. Thermal fuse TF2 senses the thermal over-load of the surge circuit. The surge circuit absorbs the energy arising from the application of over-voltage at TP5. However, in the event of an inversion of the power applied at TP5 there is no interruption of power applied to neutral pin TP6.

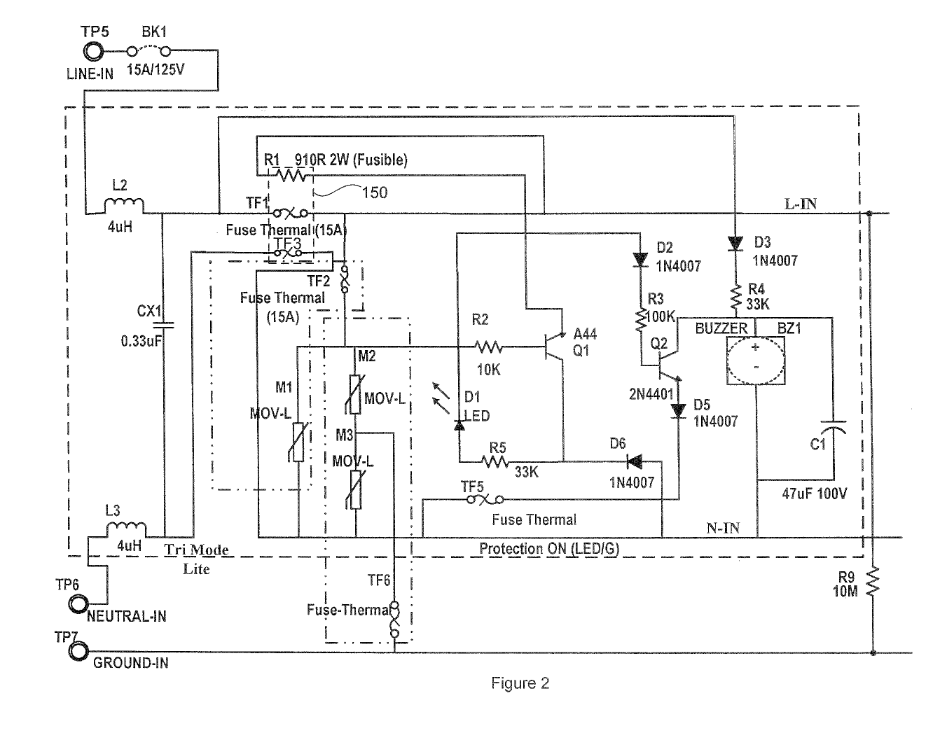

Referring now to FIG. 2, according to the present invention, thermal fuses TF1 and TF3 open to interrupt inverted power applied at TP5. Fusible resistor R1 overheats when switching circuit transistor Q1 activates. Thermal fuse TF2 senses the thermal overload of the surge circuit. The surge circuit absorbs the energy arising from the application of over-voltage at TP5. Therefore, the rapid simultaneous interruption of both line and neutral protects devices from both excessive over-voltage and inverted voltage when connected to the electric power distribution circuits of the present invention.

With continuing reference to FIG. 2, thermal bonding 150 ensures thermal fuses TF1 and TF3 open as quickly as possible in response to heating of resistor R1. Thermal bonding 150 is not required to practice the present invention and is meant only to enhance performance of components TF1, TF3 and R1 by increasing the speed by which thermal fuses TF1 and TF3 heat up. Such improved performance can be achieved by component layout whereby TF1, TF3 and R1 are disposed in close proximity with each other, Alternatively, a thermal epoxy covering these components or a mechanical thermal clip coupled to these components may be used for this purpose.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean one and only one unless explicitly so stated, but rather one or more. All structural and functional equivalents to the elements of the above-described preferred embodiment and additional embodiments that are known to those of ordinary skill in the art are hereby expressly incorporated by reference and are intended to be encompassed by the present claims. Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, it should be readily apparent to those of ordinary skill in the art that various changes and modifications in form, semiconductor material, and fabrication material detail may be made without departing from the spirit and scope of the inventions as set forth in the appended claims. No claim herein is to be construed under the provisions of 35 U.S.C. 112, sixth paragraph, unless the element is expressly recited using the phrase means for.

What is claimed is:

1. In a tri-mode over-voltage circuit protection and disconnect apparatus, the improvement
comprising:
at least one thermal fuse in both the neutral line and hot line, each said fuse being thermally coupled to a single component that generates heat sufficient to open said fuses in the event of an over-voltage event in the apparatus.
